(19) United States
(12) Patent Application Publication
(10) Pub. No.: US 2014/0166784 A1
(43) Pub. Date: Jun. 19, 2014

(54) WATER DISPENSER NOZZLE FOR AN APPLIANCE

(71) Applicant: GENERAL ELECTRIC COMPANY, Schenectady, NY (US)

(72) Inventor: Alan Joseph Mitchell, Louisville, KY (US)

(73) Assignee: GENERAL ELECTRIC COMPANY, Schenectady, NY (US)

(21) Appl. No.: 13/719,370

(22) Filed: Dec. 19, 2012

(51) Int. Cl. B05B 1/34

(52) U.S. Cl. CPC B05B 1/34
USPC 239/548

(57) ABSTRACT

A nozzle for dispensing water from an appliance is provided. The nozzle decreases the velocity of water flow so as to reduce or eliminate water splashing out of a consumer's container during dispensing while still providing a rate of flow sufficient to timely fill the container. The nozzle also retains sufficient capillary action so as to reduce or eliminate water draining from the dispenser after the consumer has removed the container. Additional aesthetic features may also be provided in certain exemplary embodiments.

### FIELD OF THE INVENTION

The subject matter of the present disclosure relates generally to a nozzle for dispensing water from an appliance.

### BACKGROUND OF THE INVENTION

Refrigerator appliances generally include one or more cabinets defining chambers for the receipt of food items for storage. Refrigerator appliances may also include features for dispensing ice and/or water. To provide ice and water, a dispenser is typically positioned on a door of the appliance. The user positions a container at the dispenser and ice, water, or both are deposited into the container depending upon the user's selection. A paddle or other type switch can be provided whereby the user can make a selection. Typically, the water is chilled by routing through one of the refrigerated chambers.

The water dispenser is commonly constructed as a single plastic tube that is connected with a water supply controlled by the user-activated paddle or switch. The diameter of the tube is usually small—i.e. about 0.2 inches or more. Because the appliance is connected directly with the user's water supply, the velocity of water as it exits the tube will typically be relatively high depending upon e.g., the pressure of the water supply connected to the appliance. This high velocity can result in water undesirably splashing out of the container—particularly if the container already has e.g., ice inside. The water can splash onto the consumer and/or onto the exterior of the appliance or floor—requiring clean up by the user.

One potential approach could be to increase the diameter of the dispensing tube so as to reduce the velocity of water exiting the dispenser. However, this approach is also unsatisfactory because it can lead to insufficient capillary action such that water in the tube continues to drain out even after the user has removed the container from the dispenser. Such draining can leave the consumer with water to clean up from the floor and/or exterior of the appliance.

Another approach could be to increase the diameter of the tube and include a check valve in the tube to reduce drip caused by a loss of capillary action. However, the check valve increases the overall cost of the appliance. In addition, the check valve can stick or other malfunction—requiring replacement or service to correct.

Accordingly, a device for dispensing water from an appliance would be useful. More particularly, a device of dispensing water from an appliance that reduces or eliminates undesirable splashing of water outside of the consumer's container would be beneficial. Such a device that can also still provide the desired amount of water flow and sufficient capillary action would also be particularly useful.

### BRIEF DESCRIPTION OF THE INVENTION

The present invention provides a nozzle for dispensing water from an appliance. The nozzle decreases the velocity of water flow so as to reduce or eliminate water splashing out of a consumer's container during dispensing while still providing a rate of flow sufficient to timely fill the container. The nozzle also retains sufficient capillary action so as to reduce or eliminate water draining from the dispenser after the consumer has removed the container. Certain additional aesthetic features may also be provided in certain exemplary embodiments. Additional aspects and advantages of the invention will be set forth in part in the following description, or may be apparent from the description, or may be learned through practice of the invention.

In one exemplary embodiment, the present invention provides a refrigerator appliance. The appliance includes a cabinet defining a chilled chamber for receipt of food articles. A door is mounted to the cabinet. The door is configured for permitting selective access to the chilled chamber of the cabinet. A dispenser is mounted to the door. The dispenser defines a dispensing recess and includes a nozzle for dispensing water. The nozzle includes a fluid inlet having an inlet cross-sectional area, CA_{INLET}. The nozzle also includes a plurality of fluid outlets having a total outlet cross-sectional area, CA_{OUTLET}, where CA_{OUTLET} is greater than CA_{INLET}.

In still another exemplary embodiment, the present invention provides a water dispenser nozzle for an appliance. The nozzle includes a tube defining a fluid inlet to the nozzle. The fluid inlet has an inlet cross-sectional area, CA_{INLET}. The nozzle also includes a nozzle base defining a plurality of fluid outlets configured for receiving water from the fluid inlet. The plurality of fluid outlets having a total outlet cross-sectional area, CA_{OUTLET}, where CA_{OUTLET} is greater than CA_{INLET}.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of an exemplary embodiment of a refrigerator appliance of the present invention.

FIG. 2 provides another front view of the exemplary embodiment of FIG. 1 with doors to a fresh food compartment shown in an open position.

FIG. 3 provides an example of a dispenser equipped with an exemplary nozzle of the present invention.

FIG. 4 illustrates a perspective view of an exemplary nozzle of the present invention while FIG. 5 depicts an exemplary component of the nozzle.

FIG. 6 illustrates an exemplary nozzle base of the present invention from the outlet side while FIG. 7 illustrates such nozzle base from an inlet side.

FIG. 8 provides an example of a dispenser equipped with another exemplary embodiment of a nozzle of the present invention.

FIG. 9 provides a cross-sectional view of the exemplary nozzle of FIG. 8.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

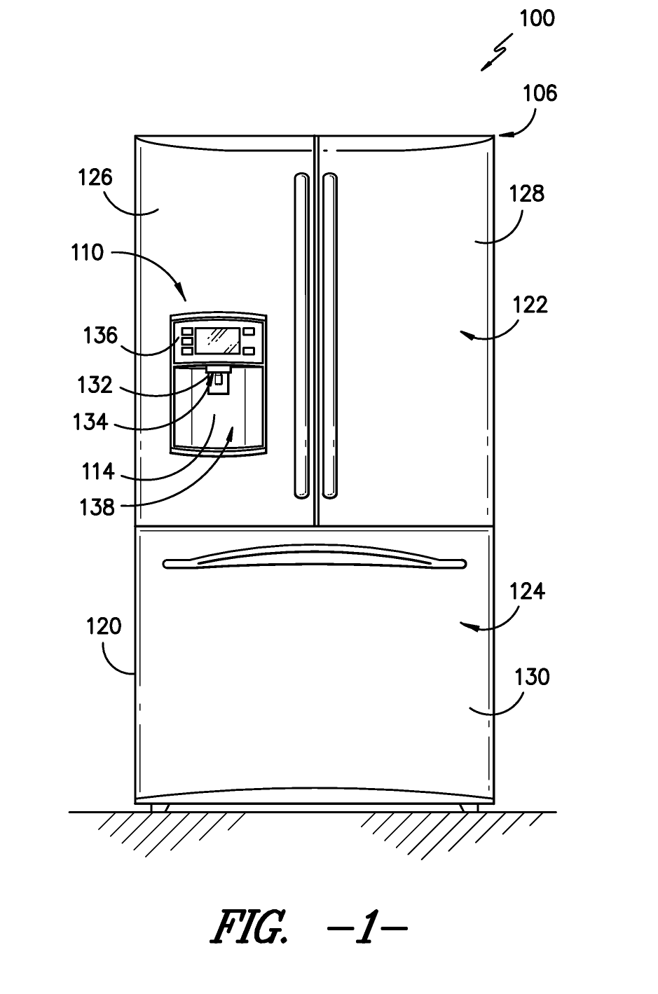

FIG. 1 is a front view of an exemplary embodiment of a refrigerator appliance 100. Refrigerator appliance 100 includes a cabinet or housing 120 defining an upper fresh food chamber 122 and a lower freezer chamber 124 arranged below the fresh food chamber 122. As such, refrigerator appliance 100 is generally referred to as a bottom mount refrigerator. In the exemplary embodiment, housing 120 also defines a mechanical compartment (not shown) for receipt of a sealed cooling system. Using the teachings disclosed herein, one of skill in the art will understand that the present invention can be used with other types of refrigerators (e.g., side-by-sides). Consequently, the description set forth herein is for illustrative purposes only and is not intended to limit the invention in any aspect.

Refrigerator doors 126, 128 are rotatably hinged to an edge of housing 120 for accessing fresh food compartment 122. A freezer door 130 is arranged below refrigerator doors 126, 128 for accessing freezer chamber 124. In the exemplary embodiment, freezer door 130 is coupled to a freezer drawer (not shown) slidably mounted within freezer chamber 124.

Refrigerator appliance 100 includes a dispensing assembly 110 for dispensing water and ice. Dispensing assembly 110 includes a dispenser 114 positioned on an exterior portion of refrigerator appliance 100. Dispenser 114 includes a discharging outlet 134 for accessing ice and water. An activation member 132 is mounted below discharging outlet 134 for operating dispenser 114. In FIG. 1, activation member 132 is shown as a paddle. However, activation member 132 may be any other suitable mechanism for signaling or indication initiating a flow of ice and/or water into a container within dispenser 114, e.g., a switch or button. A user interface panel 136 is provided for controlling the mode of operation. For example, user interface panel 136 includes a water dispensing button (not labeled) and an ice-dispensing button (not labeled) for selecting a desired mode of operation such as crushed, non-crushed ice, or water, etc.

Discharging outlet 134 and activation member 132 are an external part of dispenser 114, and are mounted in a dispensing recess or recessed portion 138 defined in an outside surface of refrigerator door 126. Recessed portion 138 is positioned at a predetermined elevation convenient for a user to access ice or water and enabling the user to access ice of water without the need to bend-over and without the need to access freezer chamber 124. In the exemplary embodiment, recessed portion 138 is positioned at a level that approximates the chest level of a user.

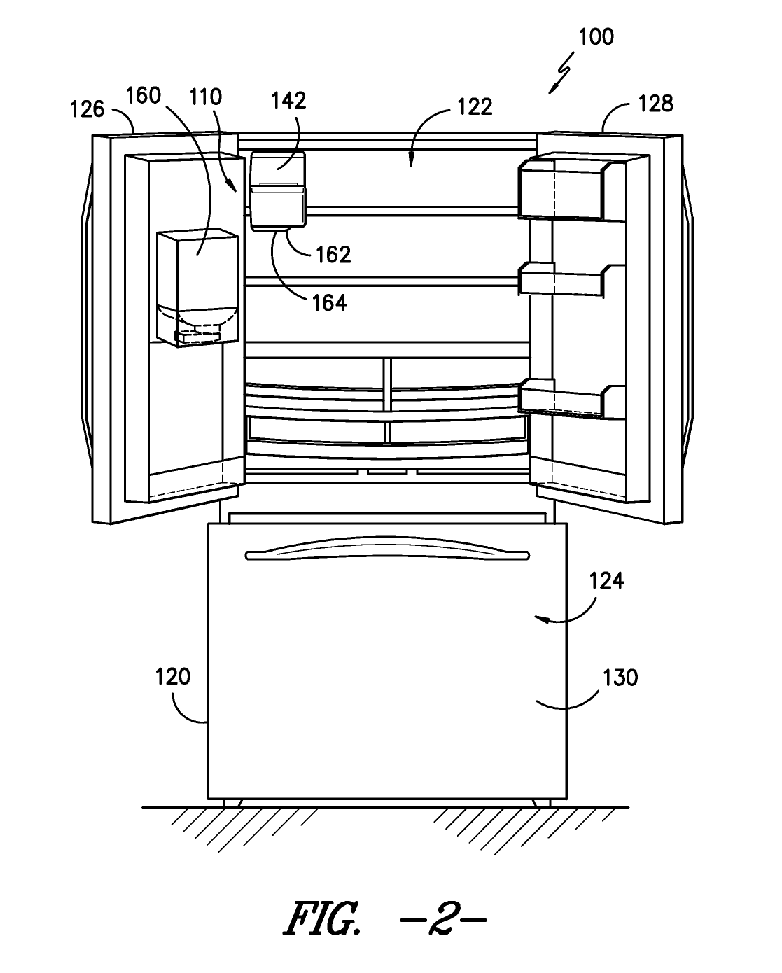

FIG. 2 is a perspective view of refrigerator appliance 100 having refrigerator doors 126, 128 in an open position to reveal the interior of the fresh food chamber 122. As such, certain components of dispensing assembly 110 are illustrated. For this exemplary embodiment, dispensing assembly 110 includes an insulated housing 142 mounted within refrigerator chamber 122. Due to insulation surrounding insulated housing 142, the temperature within insulated housing 142 can be maintained at levels different from the ambient temperature in the surrounding fresh food chamber 122.

In particular, insulated cavity 142 is constructed and arranged to operate at a temperature that facilitates producing and storing ice. More particularly, the insulated cavity contains an ice maker for creating ice and feeding the same to a receptacle 160 that is mounted on refrigerator door 126. As illustrated in FIG. 2, receptacle 160 is placed at a vertical position on refrigerator door 126 that will allow for the receipt of ice from a discharge opening 162 located along a bottom edge 164 of insulated housing 142 when refrigerator door 126 is in a closed position (shown in FIG. 1). As door 126 is closed or opened, receptacle 160 is moved in and out of position under insulated housing 142.

Alternatively, in another exemplary embodiment of the present invention, insulated housing 142 and its ice maker can be positioned directly on door 126. In still another exemplary embodiment of the present invention, in a configuration where the fresh food compartment and the freezer compartment are located side by side (as opposed to over and under as shown in FIGS. 1 and 2), the ice maker could be located on the door for the freezer compartment and directly over receptacle 160. As such, the use of an insulated housing would be unnecessary. Other configurations for the location of receptacle 160, an ice maker, and/or insulated housing 142 may be used as well.

Operation of the refrigerator appliance 100 is regulated by a controller (not shown) that is operatively coupled to user interface panel 136 and/or activation member 132 (shown in FIG. 1). Panel 136 provides selections for user manipulation of the operation of refrigerator appliance 100 such as e.g., selections between whole or crushed ice, chilled water, and/or other options as well. In response to user manipulation of the user interface panel 136, the controller operates various components of the refrigerator appliance 100. The controller may be positioned in a variety of locations throughout refrigerator appliance 100. In the illustrated embodiment shown in FIGS. 1 and 2, controller is located within beneath the user interface panel 136 on door 126. In such an embodiment, input/output (“I/O”) signals may be routed between controller and various operational components of refrigerator appliance 100. In one exemplary embodiment, the user interface panel 136 may represent a general purpose I/O (“GPIO”) device or functional block. In another exemplary embodiment, the user interface 136 may include input components, such as one or more of a variety of electrical, mechanical or electro-mechanical input devices including rotary dials, push buttons, and touch pads. The user interface 136 may be in communication with the controller via one or more signal lines or shared communication busses.

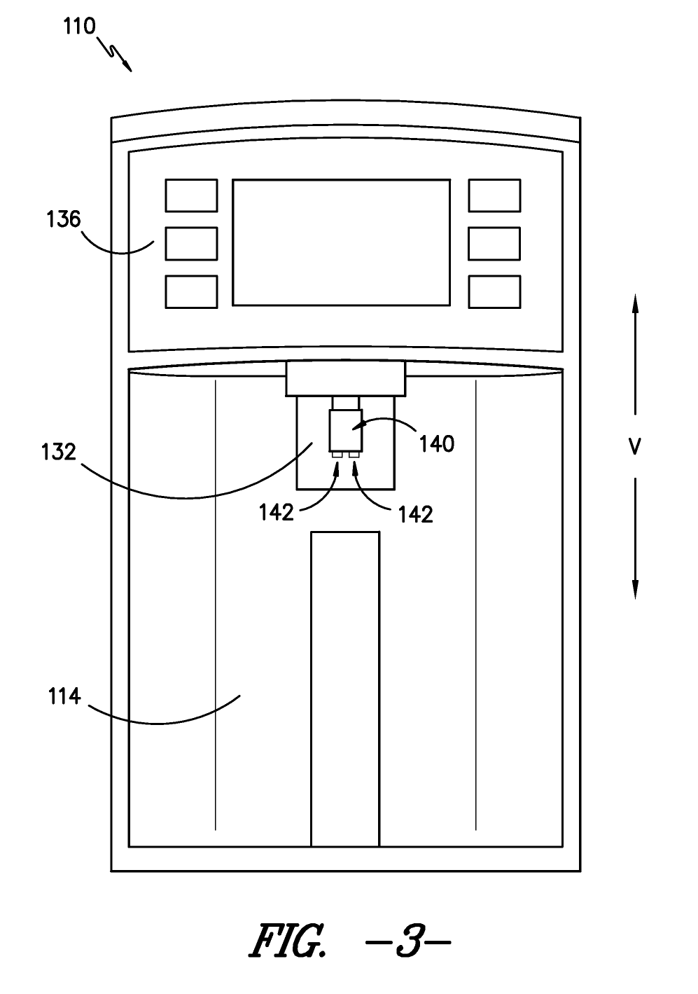

FIG. 3 provides a close-up front view of the dispenser 114 of dispensing assembly 110. An exemplary nozzle 140 of the present invention is positioned adjacent to activation member 132. Nozzle 140 includes a plurality of fluid outlets 142 through which water may flow into a container placed into the recess 138 of dispensing assembly 110 by a user of appliance 100.

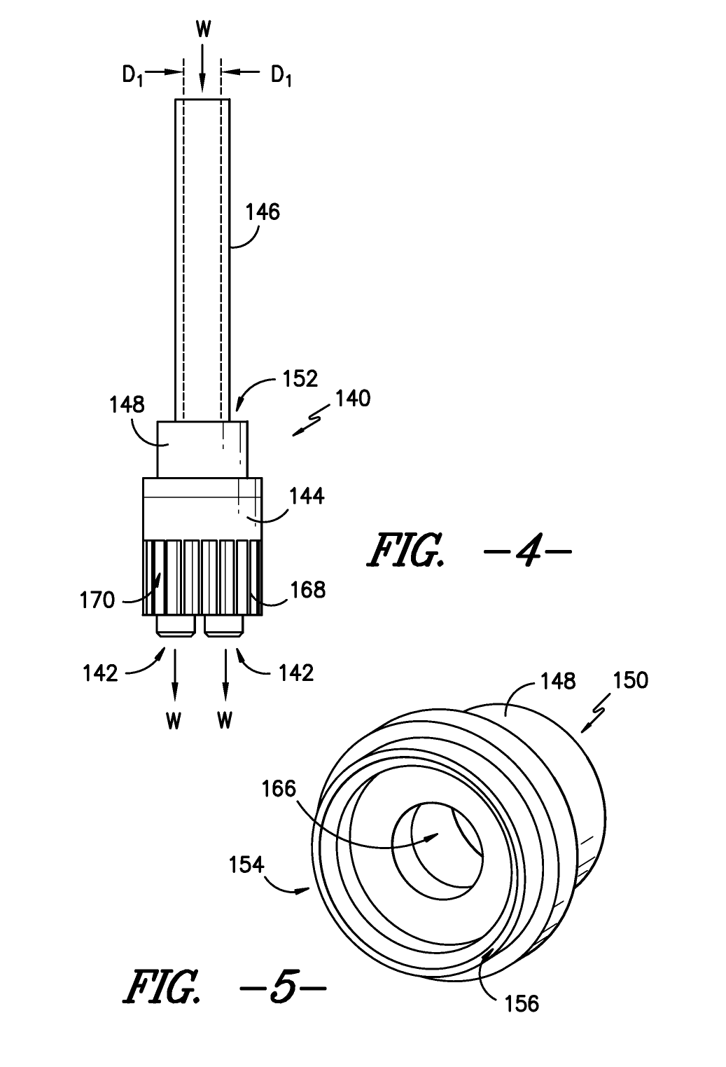

Referring now to FIGS. 4 through 7, for this exemplary embodiment, nozzle 140 includes a nozzle base 144 connected to a tube 146 by a nozzle cap 148. Nozzle cap 148 includes an open end 150 into which a distal end 152 of tube 146 is received. At open end 154, nozzle cap 148 includes a flange 156 that is received into a recess 158 (FIG. 7) of nozzle base 144. Tube 146 is connected to a water supply controlled by activation member 132 and acts as a water inlet to nozzle 140 whereby fluid may flow from the water supply, through the channel 166 in nozzle cap 148, through nozzle body 144, and exit through fluid outlets 142. Nozzle body 144, cap 148, and tube 146 may be connected by, for example, an interference fit and/or ultrasonic welding. Other techniques may be used as well.

For this exemplary embodiment, three fluid outlets 142 are shown. Using the teachings disclosed herein, however, it will be understood that two, four, or even more fluid outlets 142 may be used to create still other embodiments of the invention as well. Different arrangements of outlets 142 relative to each other may also be used. Also, although shown as circular, fluid outlets 142 may also employ other shapes such as e.g., square, triangular, or others.

Tube 146 provides a fluid inlet having an inlet cross-sectional area, CA_{INLET}, that can be readily calculated. For example, where tube 146 is circular, CA_{INLET} can be calculated as π(D₁/2)² where D₁ represents the internal diameter of tube 146 as shown in FIG. 4. As will by understood by one of skill in the art, other formulas may be used to calculate CA_{INLET} depending upon e.g., the geometry of the fluid inlet provided by tube 146.

Similarly, fluid outlets 142 together provide a total outlet cross-sectional area, CA_{OUTLET}, that can also be readily calculated. For example, the total outlet cross-sectional area, CA_{OUTLET}, provided by fluid outlets 142 of the embodiments of FIGS. 4-7 can be calculated as n(π)(D₂/2)² where D₂ represents the internal diameter of a fluid outlet 142 and n represents the total number of fluid outlets as depicted in FIG. 7. As will by understood by one of skill in the art, other formulas may be used to calculate CA_{OUTLET} depending upon e.g., the geometry of the fluid outlet provided by fluid outlets 142.

While the cross-sectional area of each individual fluid outlet 142 is less than the inlet cross-sectional area, CA_{INLET}, of tube 146, the total outlet cross-sectional area, CA_{OUTLET}, provided by all fluid outlets 142 is greater than CA_{INLET}. As such fluid outlets 142 reduce the velocity of water flow relative to the velocity through tube 146 while still providing a sufficient flow rate of water from nozzle 140. The amount by which CA_{OUTLET} should exceed CA_{INLET} can be determined based on the anticipated water pressure supplied to tube 146 and CA_{INLET} so that the velocity of the water exiting fluid outlets 142 does not cause water to undesirably splash out of the typical container placed into the dispenser recess 138 by a consumer. For example, in one exemplary embodiment of the invention, CA_{OUTLET} is in the range of 1.5 to 2 times CA_{INLET}. Other values may be used as well provided CA_{OUTLET} is greater than CA_{INLET}.

In addition, D₂ can be selected to provide sufficient capillary action that prevents water from continuing to drain from tube 146 after the consumer has removed a container from recess 138. For example, in one exemplary embodiment of the invention, D₂ is in the range of about 0.1 inches to about 0.15 inches. Other values may be used as well provided sufficient capillary action is provided.

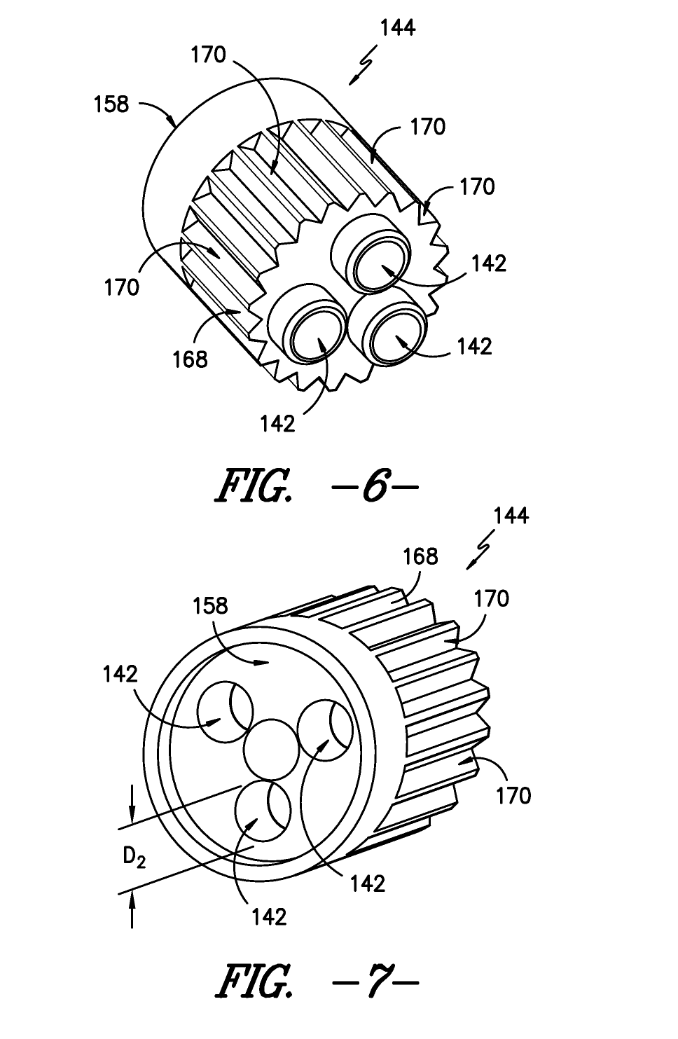

Nozzle 140 may also be equipped with one or more aesthetic features to improve consumer appeal and/or functionality of the appliance. For example, as best shown in FIGS. 4 and 6, nozzle base 144 has a circumferentially extending surface 168 that includes a plurality of facets 170 extending longitudinally along the direction of water flow W (FIG. 4) through nozzle 140. Nozzle base 144 is constructed from a light transmissive material such as a translucent or transparent material. Accordingly, by positioning a light source (such as e.g., a light emitting diode) near or in such material, base 140 will transmit light from such source so as to illuminate nozzle 140, recess 138, and/or the user's container depending upon the output of the light source. Facets 170 as shown in FIGS. 4, 6, and 7 are provided by way of example only. Other shapes and configurations may be used as well.

For the exemplary embodiment shown in FIGS. 3, 4, 6, and 7, fluid outlets 142 of nozzle 140 are arranged in a circular manner as shown. However, other arrangements of fluid outlets 142 may be used as well. For example, FIG. 3 provides another close-up front view of the dispenser 114 of dispensing assembly 110 where another exemplary nozzle 140 of the present invention is positioned adjacent to activation member 132. As with the embodiment of FIG. 3, nozzle 140 includes a plurality of fluid outlets 142 through which water may flow into a container placed into the recess 138 of dispensing assembly 110 by a user of appliance 100.

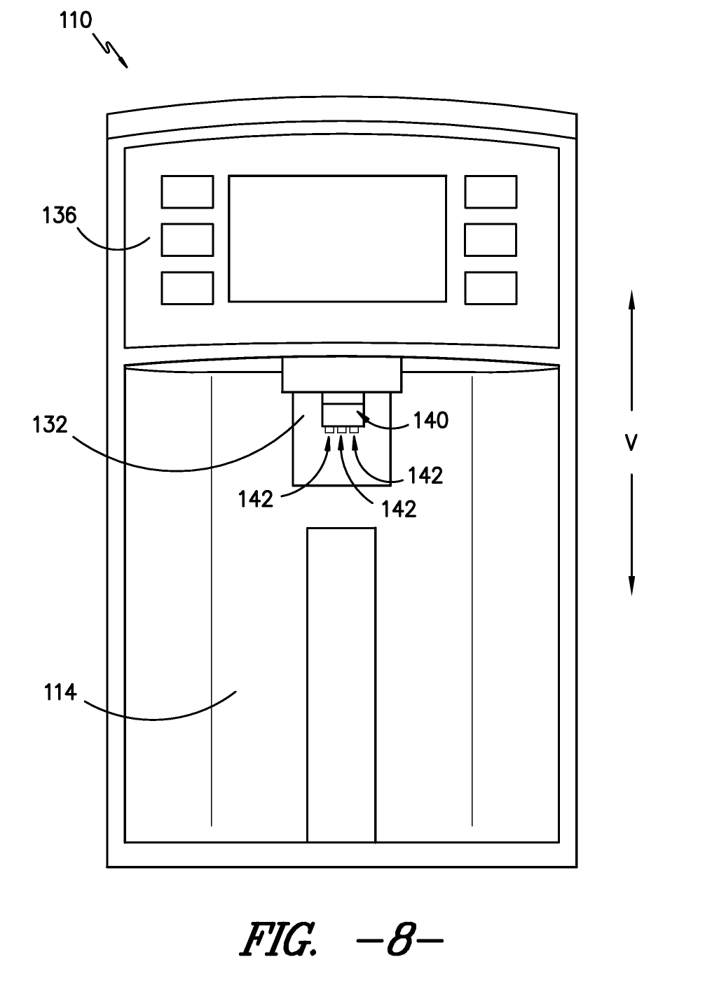

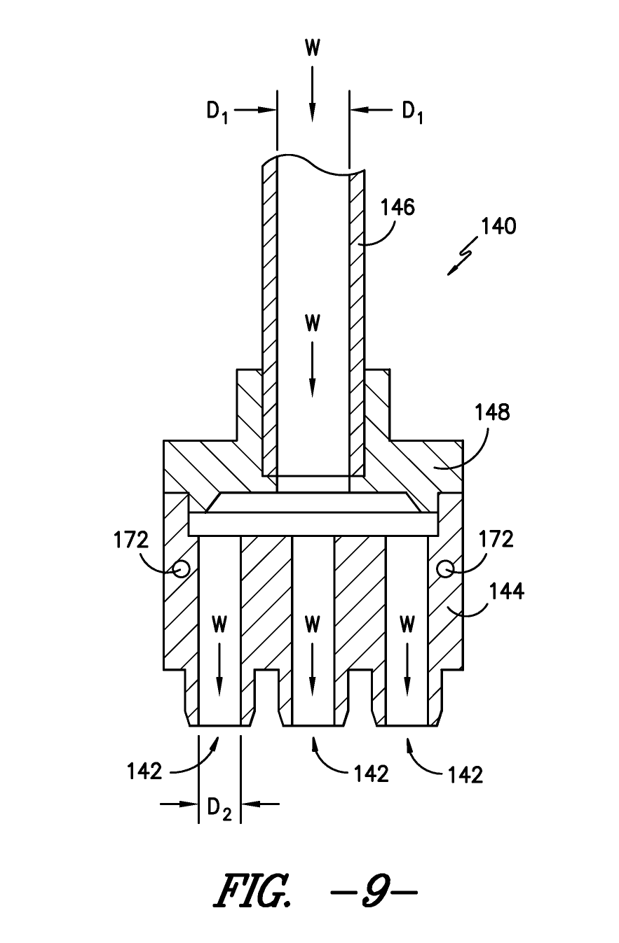

However, unlike FIG. 3, nozzle 140 as shown in FIGS. 8 and 9 has a plurality of fluid outlets 142 that are aligned within a plane parallel to the direction of the flow of water (arrows W). Again, the total outlet cross-sectional area, CA_{OUTLET}, provided by all fluid outlets 142 is greater than CA_{INLET} for tube 146. Nozzle body 144 can also be constructed e.g., from a light transmissive material and equipped with a light sources 172 as previously described.

Using the teachings disclosed herein, it will be understood that other shapes and configurations for the nozzle may be used as well and such is not limited to that shown in the figures. Additionally, although shown with a nozzle cap 148, nozzle 140 may also be constructed without a cap. For example, nozzle body 144 may be connected directly to tube 146. Other constructions may also be used.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance, comprising:
a cabinet defining a chilled chamber for receipt of food articles;
a door mounted to said cabinet, said door configured for permitting selective access to the chilled chamber of said cabinet;
a dispenser mounted to said door, said dispenser defining a dispensing recess and including a nozzle for dispensing water that comprises:
a fluid inlet having an inlet cross-sectional area, CA_{INLET};
a plurality of fluid outlets having a total outlet cross-sectional area, CA_{OUTLET}, wherein CA_{OUTLET} is greater than CA_{INLET}.

2. A refrigerator appliance as in claim 1, further comprising a tube defining said fluid inlet, said tube configured for connection with a water supply.

3. A refrigerator appliance as in claim 2, further comprising a nozzle base connected with said tube and defining said plurality of fluid outlets.

4. A refrigerator appliance as in claim 3, further comprising a nozzle cap into which a distal and of said tube is received, and wherein said nozzle base defines a recess into which said nozzle cap is received.

5. A refrigerator appliance as in claim 4, wherein said nozzle base is ultrasonically welded to said nozzle cap.

6. A refrigerator appliance as in claim 3, wherein said nozzle base comprises a translucent or transparent material and has a circumferentially-extending surface configured with a plurality of facets extending longitudinally along the direction of water flow through the nozzle.

7. A refrigerator appliance as in claim 6, further comprising a light source configured for directing light into said nozzle base for transmission through said plurality of facets.

8. A refrigerator appliance as in claim 1, wherein said fluid outlets each have an internal diameter in the range of about 0.1 inch to about 0.15 inch so as to provide capillary action in each of said fluid outlets.

9. A refrigerator appliance as in claim 1, wherein said fluid outlets are positioned in a circular manner relative to each other.

10. A water dispenser nozzle for an appliance, comprising:
a tube defining a fluid inlet to the nozzle, said fluid inlet having an inlet cross-sectional area, CA_{INLET}; and,
a nozzle base defining a plurality of fluid outlets configured for receiving water from said fluid inlet, said plurality of fluids outlets having a total outlet cross-sectional area, CA_{OUTLET}, wherein CA_{OUTLET} is greater than CA_{INLET}.

11. A water dispenser nozzle for an appliance as in claim 10, wherein said fluid outlets each have an internal diameter in the range of 0.1 inch to 0.15 inch.

12. A water dispenser nozzle for an appliance as in claim 10, wherein said fluid outlets are positioned in a non-circular manner relative to each other.

13. A water dispenser nozzle for an appliance as in claim 10, further comprising a cap connected with said tube, and wherein said nozzle base defines a recess into which a said cap is received.

14. A water dispenser nozzle for an appliance as in claim 13, wherein said nozzle base is ultrasonically welded to said cap.

15. A water dispenser nozzle for an appliance as in claim 10, wherein said nozzle base comprises a light transmissive material and has a circumferentially-extending surface configured with a plurality of facets extending longitudinally along the direction of water flow through the nozzle.

16. A water dispenser nozzle for an appliance as in claim 15, further comprising a light source configured for directing light into said nozzle base for transmission through said plurality of facets.

17. A water dispenser nozzle for an appliance as in claim 16, wherein said light source comprises a light emitting diode.
